(19) United States
(12) Patent Application Publication
(10) Pub. No.: US 2011/0275392 A1
(43) Pub. Date: Nov. 10, 2011

(54) Method for Channel Estimation, Base Station and Mobile Node

(76) Inventors: Thomas Haustein, Potsdam (DE); Egon Schulz, Munchen (DE); Wolfgang Zirwas, Munchen (DE)

(21) Appl. No.: 13/144,562

(22) PCT Filed: Jan. 15, 2009
(86) PCT No.: PCT/EP09/50431

§ 371 Date: Jul. 14, 2011

(51) Int. Cl. H04W 4/00; H04W 24/00

(52) U.S. Cl. 455/500; 455/67.11

(57) ABSTRACT

The present invention refers to channel estimation in a communications network. According to the present invention, first two reference signals are transmitted by a base station to a set of mobile nodes in said communications network, wherein said base station includes first two antenna ports and wherein each of said first two reference signals refers to one antenna port of said first two antenna ports. Further, at least one second reference signal is transmitted by said base station to a cooperating mobile node, wherein said cooperating mobile node is included in said set of mobile nodes; said cooperating mobile node is assigned to a cooperation area in said communications network, said cooperation area being defined by said base station; and said at least one second reference signal refers to a corresponding further antenna port of further antenna ports included in said base station.

### FIELD OF THE INVENTION

The present invention refers to a method for channel estimation in a communications network, in particular in a communications network utilizing cooperative antenna systems.

In particular, the present invention refers to a method for channel estimation. The present invention further refers to an accordingly configured base station or NodeB, respectively, and to an accordingly configured mobile node or user equipment, respectively.

### BACKGROUND OF THE INVENTION

In communications networks, in particular in telecommunications networks increasing the system performance is still a challenging task. To overcome inter cell interference limits and to exploit improved radio channels cooperative antenna systems (COOPA) are exploited in communications networks. By use of COOPA, at least one cooperation area is defined, within scope of which base stations assigned to the cooperation area are cooperating when performing communication with user equipments or mobile nodes in the communications network.

COOPA, based on intra nodeB or intra base station cooperation between adjacent sectors of a site, is promising as the most basic cooperation scheme, as it can be implemented without any backbone network involved. Similar are distributed antenna systems, where the antenna elements (AE) of each sector are spatially distributed. The transmission stations—typically remote radio heads—can be connected with the based band unit at the nodeB or base station site over fibers, but without inclusion of the backbone network.

COOPA systems require accurate channel estimation, which has to be fed back to nodesB or base stations, where it will be used for pre-coding in the cooperation areas. This represents one of major challenges, especially due to the inter cell interference in (mobile) communications systems.

In communications networks utilizing COOPA systems, each cell has to broadcast continuously a grid of common reference signals for all antenna elements. According to Long Term Evolution or LTE respectively (e.g., Release 8), for example, each antenna element can comprise 1, 2, or 4 antenna ports per sector. Here, one reference signal is transmitted for each of the antenna ports.

In FIG. 1, an embodiment of transmission of reference signals from two transmission stations “Tx1” and “Tx2” are shown in time and frequency direction, wherein the time scale is visualized by the vertical direction and the frequency domain is visualized by the horizontal direction. Blocks marked by D represent data blocks, blocks marked by T₁ represent reference symbols or signals of “Tx1”, and blocks marked by T₂ represent reference symbols or signals of “Tx2”. The time scale in FIG. 1 refers to 0.5 ms. User equipments or mobile nodes, which receive these reference signals or symbols, will do channel state information estimation based on this exemplary reference signal grid by proper interpolation algorithms.

For COOPA systems each user equipment or mobile node has to estimate at least those radio channels to such NodesB or base stations, which are involved in the communications area the corresponding user equipment or mobile node is attached to. To make things even more challenging, channel state information accuracy for high performance COOPA systems should be better compared to conventional cellular systems, as otherwise pre-coding accuracy in downlink might be poor.

Interference rejection combining is seen as another significant ingredient of COOPA systems. As several studies have revealed, interference rejection combining relies on high quality channel state information estimation.

In case of a multi-cell scenario the same reference signals are transmitted for synchronized networks at the same time so that there will be significant inter reference signal interference between the different cells. According to known techniques, this issue can be partly overcome by assignment of different cell ID specific sequences. This is the case, for example, in the LTE standard. So in case of estimation over one full frame length, which corresponds the length of the reference signals or sequences, there will be some crosstalk reduction between the different common reference sequences from different cells. However, a full orthogonality between all cells cannot be provided due to limited resources. Therefore, the residual channel estimation performance is still poor according to the known techniques.

Thus, there is still a need for improving of performance in communications networks, at least with regard to accurate channel estimation.

### SUMMARY OF THE INVENTION

Object of the present invention is improving of performance in communications networks, in particular, in communications networks utilizing COOPA systems.

This object is achieved by a method for channel estimation in a communications network comprising features according to claim 1, a computer program product comprising features according to claim 10, a data carrier comprising features according to claim 11, a base station comprising features according to claim 12, and a mobile node comprising features according to claim 13.

Further embodiments of the present invention are provided with the corresponding dependent claims.

The object of the present invention is achieved by a method for channel estimation in a communications network, wherein said method comprises: transmitting of first two reference signals by a base station to a set of mobile nodes in said communications network, wherein said base station comprises first two antenna ports and wherein each of said first two reference signals refers to one antenna port of said first two antenna ports; and transmitting of at least one second reference signal by said base station to a cooperating mobile node, wherein: said cooperating mobile node is comprised in said set of mobile nodes; said cooperating mobile node is assigned to a cooperation area in said communications network, said cooperation area being defined by said base station; and said at least one second reference signal refers to one further antenna port of further antenna ports comprised in said base station.

In this way, by transmitting of reference signals according to the present invention and by use of the transmitted reference signals for channel estimation, accurate and efficient channel estimation in COOPA systems, exploited in communications networks, is achieved.

Further, by transmitting of reference signals according to the present invention and by use of the transmitted reference signals for channel estimation, performance of communications networks utilizing COOPA systems and performance of COOPA systems themselves is increased significantly.

According to an embodiment of the present invention, said method comprises transmitting of a control message by said base station to said cooperating mobile node, said control message indicating that said cooperating mobile node is assigned to said cooperation area, wherein said at least one second reference signal is transmitted after said transmitting of said control message.

According to an embodiment of the present invention, said at least one second reference signal is transmitted in a message indicating availability of said further antenna ports.

According to a further embodiment of the present invention, said method comprises dividing of a frequency band of said basis station into: a first sub band configured for said transmitting of said first two reference signals; and a second sub band configured for said transmitting of said at least one second reference signal.

Further, according to an embodiment of the present invention, said second sub band is configured for said transmitting of said first two reference signals.

According to a further embodiment of the present invention, said transmitting of said at least one second reference signal is performed by use of a whole frequency band.

According to an embodiment of the present invention, said method comprises transmitting of at least one dedicated reference signal by said base station to said cooperating mobile node after assigning of said cooperating mobile node to said cooperation area.

According to a further embodiment of the present invention, said at least one second reference signal is precoded before said transmitting of said at least one second reference signal.

According to an embodiment of the present invention, said at least one second reference signal represents a resource block.

The object of the present invention is achieved by a computer program product comprising a code, the code being configured to implement and/or perform the method for channel estimation as sketched above and described in more detail below.

According to an embodiment of the present invention, the code is embodied on a data carrier.

According to a further embodiment of the present invention, the computer program product is configured to perform said method when the computer program product is executed by a processing unit like a processor, for example.

Additionally, the object of the present invention is achieved by a data carrier comprising the computer program product as described above.

Moreover, the object of the present invention is achieved by a base station, wherein said base station comprises a transmitting module, said transmitting module being configured for: transmitting of first two reference signals to a set of mobile nodes in said communications network, wherein said base station comprises first two antenna ports and wherein each of said first two reference signals refers to one antenna port of said first two antenna ports; and transmitting of at least one second reference signal to a cooperating mobile node, wherein: said cooperating mobile node is comprised in said set of mobile nodes; said cooperating mobile node is assigned to a cooperation area in said communications network, said cooperation area being defined by said base station; and said at least one second reference signal refers to a corresponding further antenna port of further antenna ports comprised in said base station.

Further, the object of the present invention is achieved also by a mobile node, wherein said mobile node comprises a receiving module, said receiving module being configured for: receiving of first two reference signals from a base station in a communications network, wherein said base station comprises first two antenna ports and wherein each of said first two reference signals refers to one antenna port of said first two antenna ports; and receiving of at least one second reference signal from said base station, if said mobile node is assigned to a cooperation area in said communications network, said cooperation area being defined by said base station, wherein said at least one second reference signal refers to one further antenna port of further antenna ports comprised in said base station.

By use of the present invention, in particular, by transmitting of reference signals according to the present invention and by using them for channel estimation, a considerable improvement of performance in communications networks utilizing COOPA systems is achieved.

Further, the present invention can be implemented in an efficient and effective way. At the same time, accurate channel estimation is enabled, which in turn improves performance of many further processes and components in communications networks being based on accurate channel estimation and/or involving results of channel estimation. Thus, for example, interference rejection can be reduced considerably when performing channel estimation according to the present invention.

### BRIEF DESCRIPTION OF THE DRAWINGS

The present invention will be understood more clearly from the following description of the preferred embodiments of the invention read in conjunction with the attached drawings, in which:

FIG. 1 shows a grid of common reference signals transmitted by a base station for all antenna elements of the base station to mobile nodes in a communications network according to state of art;

FIG. 2 shows a cooperation area in a communications network, with regard to which channel estimation according to the present invention can be performed;

FIG. 3 shows communication between a base station and mobile nodes involved in a communications area in a communications network, with regard to which channel estimation according to the present invention can be performed

FIG. 4 shows a diagram pointing out methodology for channel estimation in a communications network, utilizing a COOPA system, according to an embodiment of the present invention; and

FIG. 5 shows a grid of reference signals transmitted by a base station to mobile nodes in a communications network according to an embodiment of the present invention.

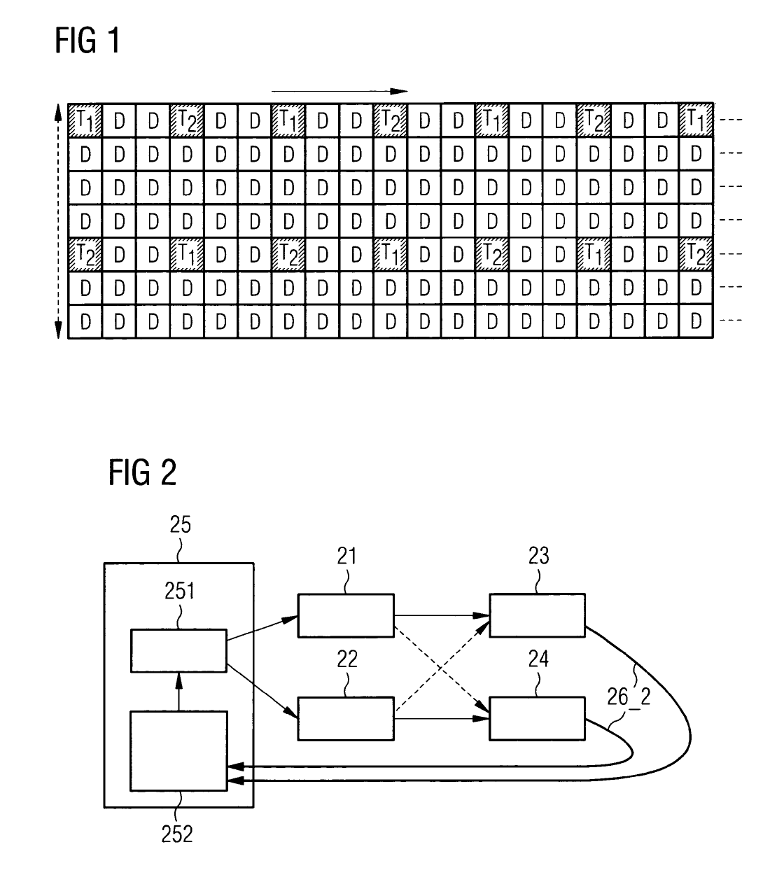

### DESCRIPTION OF THE PREFERRED EMBODIMENTS

In FIG. 2, a cooperation area in a communications network is shown, with regard to which channel estimation according to the present invention can be performed. In general, a cooperation area of a COOPA system in a communications network is defined by at least two base stations of the communications network, which are cooperating when communicating with mobile nodes in said communications network.

According to the embodiment of FIG. 2, the cooperation area comprises two base stations 21, 22 and two mobile nodes 23, 24. Communication in the cooperation area is established by use of a COOPA system. As already pointed out above, use of COOPA systems in communications networks is common. According to the present invention, several types of known COOPA systems can be exploited.

According to the present embodiment, a central unit 25 of the cooperation area performs common signal pre-coding, which is basically a matrix multiplication of all data signals with a pre-coding matrix 251. In case of zero forcing, the pre-coding matrix will be a pseudo inverse matrix of the overall channel matrix. According to the present embodiment, a codebook based pre-coding is used exemplary. Here, it has to be noted that the present invention is not restricted to codebook based pre-coding only.

According to the present embodiment, the pre-coding matrix 251 is selected from a code-book 252 based on estimated radio channels between the involved base stations 21, 22 and mobile nodes 23, 24, e.g., by using uplink-downlink reciprocity for TDD (Time-Division Duplex) systems or by explicit signalling by the mobile nodes or user equipments 23, 24. The code-book 252 is managed and provided by the central unit 25 of the cooperation area. The use of the common pre-coding matrix 251 by the base stations 21, 22 in the cooperation area is illustrated by arrows connecting the pre-coding matrix 251 and the corresponding base stations 21, 22.

According to the present embodiment, a first mobile node or user equipment 23 is assigned to a first base station 21 and is supposed to receive data over a transmission channel presented as an arrow from the base station 21 to the mobile node 23. A second mobile node or user equipment 24 is assigned to a second base station 22 and is supposed to receive data over a transmission channel presented as an arrow from the base station 22 to the mobile node 24.

When operating communication between the first base station 21 and the first mobile node 23 and between the second base station 22 and the second mobile node 24, the first mobile node 23 will receive signals also from the second base station 22 and the second mobile node 24 will receive signals also from the first base station 21.

To substantially cancel interference caused by first data received at the first mobile node 23 from the first base station 21 and by second data received at the second mobile node 24 from the second base station 22, joint transmission is used according to the present embodiment. In particular, the joint transmission is performed by transmitting the first data from the first base station 21 to the second mobile node 24 and by transmitting the second data from the second base station 22 to the first mobile node 23. In FIG. 2, this transmission is shown by the interrupted arrows between the corresponding base stations 21, 22 and mobile nodes 23, 24. According to the present embodiment, transmission of data is provided by multiplying data to be transmitted on a channel by the corresponding weight factor of the channel. In FIG. 2 the channels are shown by continuous or interrupted arrow. The weight factors of communications channels are obtained from pre-coding matrix 251 of the central unit 25 of the cooperation area. The coordinated obtaining of weight factors of channels in the cooperation area is visualized by arrows connecting the pre-coding matrix 251 (provided by the central unit 25 of the cooperation area) and the base stations 21, 22 in FIG. 2.

Further, according to the present embodiment the pre-coding matrix 251 is selected from the code-book based on different preferred matrix indices feedbacks 26_1, 26_2 from the mobile nodes 23, 24.

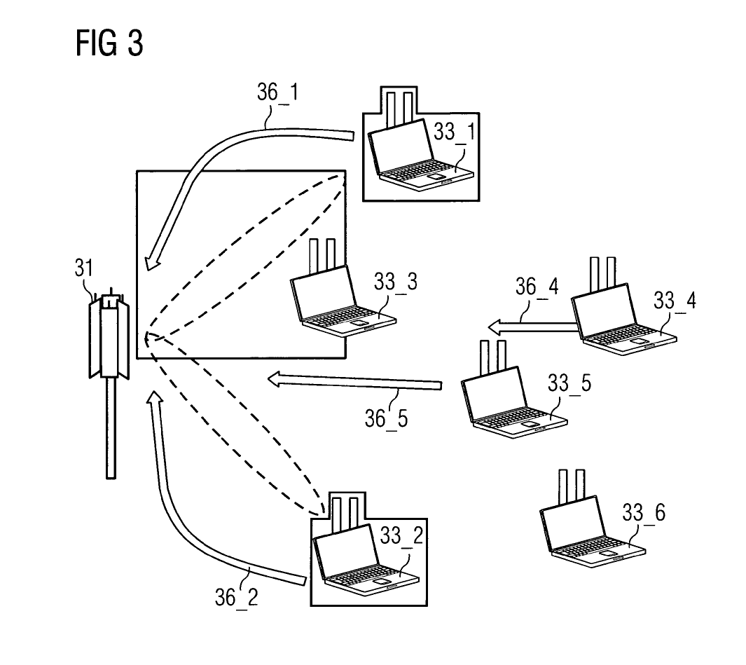

FIG. 3 shows communicating between a base station 31 and mobile nodes 33_1, 33_2, 33_3, 33_4, 33_5, 33_6 involved in a communications area in a communications network, with regard to which channel estimation according to the present invention can be performed.

To perform common signal pre-coding, corresponding pre-coding matrixes are selected from a code-book based on different preferred matrix indices feedbacks 36_1, 36_2, 36_4, 36_5 from the mobile nodes 33_1, 33_2, 33_3, 33_4, 33_5, 33_6 involved in the communications area.

According to the present embodiment provided by FIG. 3, preferred matrix indices feedbacks 36_1, 36_2, 36_4, 36_5 are provided by mobile nodes 33_1, 33_2, 33_4, and 33_5 to the base station 31 to enable selecting of corresponding pre-coding matrixes and, thus, to enable common signal pre-coding.

When considering FIG. 2 and FIG. 3, it becomes apparent that COOPA systems require accurate channel estimation, which has to be fed back to base stations or NodesB 21, 22, 31, where it will be used for pre-coding in the corresponding cooperation areas. As already mentioned above, this represents a major challenge, especially due to the inter cell interference in mobile communications networks and often due to throughput limitations of feedback channels.

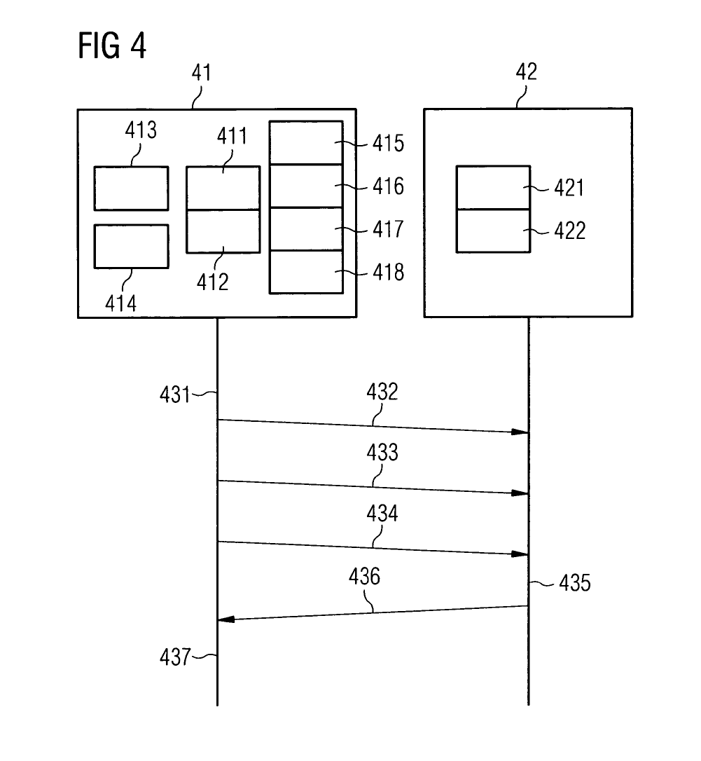

FIG. 4 shows a diagram pointing out methodology for channel estimation in a communications network, utilizing a COOPA system, according to an embodiment of the present invention.

In particular, according to the present embodiment communication of reference signals between a base station or NodeB 41 and a mobile node or user equipment 42, to enable accurate channel estimation, is shown.

According to the present embodiment, the base station or NodeB 41 comprises a transmitting module 411, a receiving module 412, a frequency band dividing module 413, and a channel estimating module 414. The user equipment or mobile node 42, in turn, comprises a receiving module 422 and a transmitting module 421. Here, it has to be pointed out that both the base station or NodeB 41 and the user equipment or mobile node 42 can comprise also further modules. The present invention is not restricted to the modules listed above. Further, also combining of the modules of the base station or NodeB 41 and of the user equipment or mobile node 42 is possible. The present invention allows several configurations and arrangements of the modules and their functionalities.

According to the present embodiment, the base station or NodeB 41 comprises first two antenna ports 415, 416 configured for communication with mobile nodes or user equipments 42 in the communications network.

The transmitting module 411 of the base station or NodeB 41 is configured for transmitting of first two reference signals to all mobile nodes in said communications network, wherein each of said first two reference signals refers to one antenna port 415 416 of said first two antenna ports.

Additionally, the base station or NodeB 41 comprises further antenna ports 417, 418. The transmitting module 411 is configured for transmitting of second or additional reference signals to at least one mobile node or user equipment 42, which is assigned to cooperation area defined by the base station or NodeB 41. Here, each of the additional or second reference signals refers to one of the further antenna ports 417, 418. According to the present embodiment, at least one second or additional reference signal is transmitted.

The reference signals transmitted by the base station 41 for antenna ports 415, 416 can be, for example, reference signals defined by a certain standard. According to the present invention they are determined and provided according to the LTE Release 8 standard. Thus, they represent a two-dimensional reference signal sequence, which is generated as the symbol-by-symbol product of a two-dimensional orthogonal sequence and a two-dimensional pseudo-random sequence. In this way, a concrete standard like LTE Release 8 standard, for example, can be supported by the present invention.

The reference signals transmitted by the base station 41 for the further antenna ports 417, 418, will not be taken into account by a particular standard like LTE Release 8, for example. Thus, they can be designed in a standard independent way. In particular, they can be designed in any way, which maximizes overall multi-cell channel estimation performance. Thus, they can be derived by multiplying Walsh Hadamard sequences, for example. In this way, channel estimation performance can be improved significantly. In particular, the allocation of channels can be performed in such a way that for nearby interferers, which will typically generate more interference, reference sequences (or signals) are allocated, which are orthogonal already for short sequence lengths.

At such resource blocks, where LTE Release 8 mobile nodes or user equipments are supported by the base station or NodeB 41 these mobile nodes or user equipments will expect data symbols instead of reference signals. Therefore, the frequency band can be divided into a sub band for Release 8 mobile nodes or user equipments and another one for cooperative LTE advanced mobile nodes or user equipments 41. This frequency band division step 431 can be performed, for example, by the frequency band dividing module 413 of the base station or NodeB 41. In this way, the transmission of additional or further reference signals for further antenna ports 417, 418 can than limited in an effective way to the sub band for the (LTE) advanced mobile nodes or user equipments 42, i.e., mobile nodes or user equipments 42 assigned to the cooperation area of the base station 42 and configured for receiving of the further or additional reference signals.

Thus in step 432, the first two reference signals for antenna ports 415, 416 are transmitted (e.g., broadcasted) to all mobile nodes by the transmitting module 411 by use of the first sub band configured for transmitting of the first two (LTE Release 8 conform) reference signals. These reference signals are received at the mobile node or user equipment 42, e.g., by accordingly configured receiving module 422 of the mobile node or user equipment 42.

According to the present embodiment, the advanced mobile nodes or user equipments 42, which are assigned to the cooperation area of the base station or NodeB 41, can be informed about the availability of the further or additional reference signals determined for the further antenna ports 417, 418. This is performed in step 433.

In particular, the step 433 can be performed in several ways. Thus, for example, the advanced mobile nodes or user equipments 42 can expect the further or additional reference signals as soon as they are set into COOPA mode by a corresponding control message, transmitted by the transmitting module 411 of the base station or NodeB 41 to these mobile nodes or user equipments 42. The receiving module 421 is then configured for receiving of this control message. In this way, further control signalling for the further or additional reference signals can be avoided.

A further way of performing the step 413 can be done by use of additional broadcast or control messages to inform the advanced mobile nodes or user equipments 42 about the location or density of the additional or further reference signals. These additional broadcast or control messages can be transmitted by the transmitting module 411 of the base station or NodeB 41. An additional broadcast or control message is then received by the accordingly configured receiving module 422 of the mobile node or user equipment 42.

Then in step 434 the transmitting module 411 of the base station or NodeB 41 transmits the further or additional reference signals to the advanced mobile nodes or user equipments 42, which are assigned to the cooperation area of the base station or NodeB 41, by use of the second sub band configured for transmitting of the further or additional reference signals. The mobile node or user equipment 42 will then receive the further or additional reference signals by use of the correspondingly configured receiving module 422.

In step 435, the mobile node or user equipment 42 determines reference signals, which will be transmitted to the base station or NodeB 41 for channel estimation. In step 436, the transmitting module 421 transmits then the determined reference signals to the base station or NodeB 42. Finally, in step 437, channel estimation is performed (e.g., by the channel estimating module 414).

In following, some further embodiments of the present invention will be described shortly.

According to one embodiment of the present invention, instead of using two frequency sub bands the additional or further reference signals can be inserted over the full frequency band, i.e. in case of a 20 MHz system, for example, into all 100 resource blocks. According to this embodiment, mobile nodes or user equipments directed to a particular standard like LTE Release 8, for example, will suffer, as there will be reference signals, which are not standard (e.g., LTE Release 8) conform signals. These reference signals can then be seen just as additional bit errors, which can be overcome by stronger coding gains or hybrid automatic repeat request retransmissions. This solution can be helpful, for example, in case that only a small number of mobile nodes or user equipments directed to a particular standard (like LTE Release 8, for example). In such case, this small performance loss might be acceptable. According to this embodiment, the advantage is achieved that each base station or NodeB can assign standard relevant (e.g., LTE Release 8) and standard (e.g., LTE) advanced mobile nodes or user equipments on any resource block so that there are no scheduling losses and no need to coordinate the reference signals over different base stations or NodesB.

According to a further embodiment of the present invention, conventional resource blocks can be transmitted to standard relevant (e.g., for LTE Release 8) mobile nodes or user equipments, without any further or additional reference signals to avoid the above mentioned performance losses due to higher bit error rates. According to this embodiment, there will be no further or additional reference signals. To allow for channel estimation on the reference signals where actually data are transmitted the currently transmitted data elements on these reference signals may be used for channel estimation. This will be possible as soon as the advanced user equipments or mobile nodes know which data have been transmitted on these reference signals. For this purpose, additional redundancy is transmitted for these reference signals in a specific (LTE) advanced control channel or resource block or piggy packed/included in a (LTE) advanced resource block.

According to a further embodiment of the present invention, dedicated reference signals are transmitted after a cooperation area has been defined. According to this embodiment, a dedicated pre-coding appropriate for the additional or further reference signals is applied, which gives additional beam forming gain for the channel estimation while interference into other cells is reduced.

By use of the present invention as explained exemplary above by use of the embodiments of the present invention, an improved performance for multi cell channel estimation is achieved, which is the most important issue for cooperative transmission schemes, as COOPA relies heavily on the channel state information estimation accuracy.

Further, another application which requires accurate multi-cell channel estimation is interference rejection combining algorithms. Interference rejection combining algorithms provide high gains only in case that there is detailed knowledge about all interferers, which should be reduced. By use of the present invention, performance of the interference rejection combining algorithms is improved.

Moreover, the present invention can be implemented in an efficient and effective way and enables a flexible advancing of known standards like LTE Release 8, for example.

Additionally, when using Walsh Hadamard sequences for defining of the further or additional reference signals, an easy and effective implementation of the present invention is enabled.

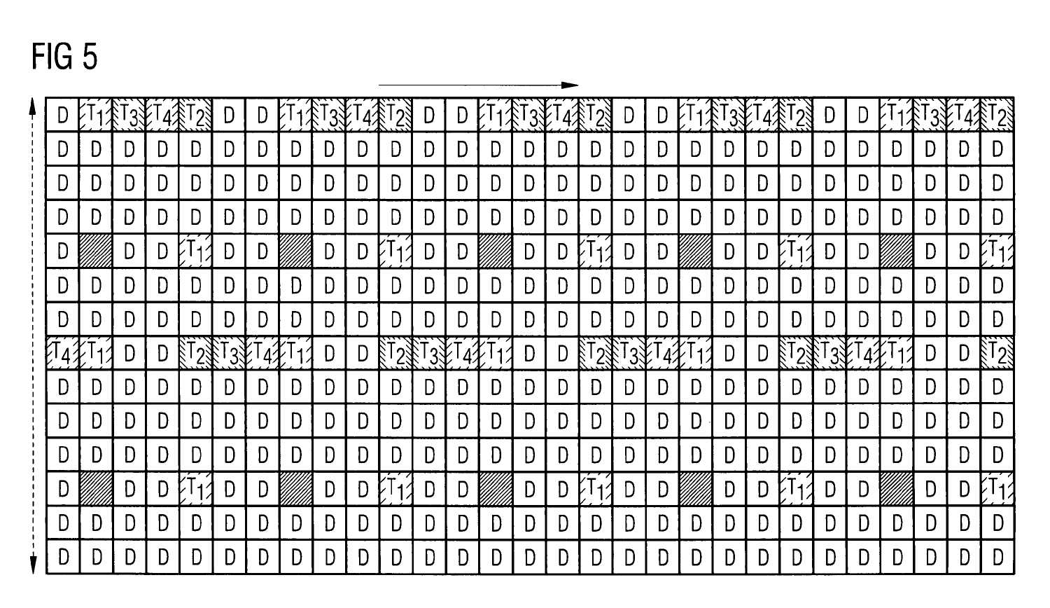

Finally, FIG. 5 shows a grid of reference signals transmitted by a base station to mobile nodes in a communications network according to an embodiment of the present invention, in particular according to the embodiment provided by FIG. 4.

The transmission of reference signals is shown in time and frequency direction, wherein the time scale is visualized by the vertical direction and the frequency domain is visualized by the horizontal direction. Blocks marked by D represent data blocks, blocks marked by T₁ represent reference symbols or signals for the antenna port 415, blocks marked by T₂ represent reference symbols or signals for the antenna port 416, blocks marked by T₃ represent further or additional reference signals for the further antenna port 417, and blocks marked by T₄ represent further or additional reference signals for the further antenna port 418. The time scale in FIG. 5 refers to 1 ms.

Thus, the present invention refers to channel estimation in a communications network. According to the present invention, first two reference signals are transmitted by a base station to a set of mobile nodes in said communications network, wherein said base station comprises first two antenna ports and wherein each of said first two reference signals refers to one antenna port of said first two antenna ports. Further, second reference signals are transmitted by said base station to a cooperating mobile node, wherein said cooperating mobile node is comprised in said set of mobile nodes; said cooperating mobile node is assigned to a cooperation area in said communications network, said cooperation area being defined by said base station; and each of said second reference signals refers to one further antenna port of further antenna ports comprised in said base station.

When considering embodiments and applications of this invention shown and described above, it should be apparent to those skilled in the art that many more modifications (than mentioned above) are possible without departing from the inventive concept described herein. Therefore, the present invention is not restricted to the above presented embodiments only and can vary within the scope of the claims. Thus, it is intended that the foregoing detailed description should be regarded as illustrative rather than limiting and that it should be understood that the following claims include all equivalents described in these claims, which are intended to define the scope of the present invention. Further, it has to be pointed out, that the foregoing description is not intended to disavow the scope of the invention as claimed or to disavow any equivalents thereof.

### LIST OF REFERENCES

21 base station or NodeB respectively
22 base station or NodeB respectively
23 user equipment or mobile node respectively
24 user equipment or mobile node respectively
25 central unit of a cooperation area
251 a pre-coding matrix
252 a code-book
26_1 preferred matrix indices feedback
26_2 preferred matrix indices feedback
31 base station or NodeB respectively
33_1 user equipment or mobile node respectively
33_2 user equipment or mobile node respectively
33_3 user equipment or mobile node respectively
33_4 user equipment or mobile node respectively
33_5 user equipment or mobile node respectively
33_6 user equipment or mobile node respectively
36_1 preferred matrix indices feedback
36_2 preferred matrix indices feedback
36_4 preferred matrix indices feedback
36_5 preferred matrix indices feedback
41 base station or NodeB respectively
411 transmitting module
412 receiving module
413 frequency band dividing module
414 channel estimating module
42 user equipment or mobile node respectively
421 transmitting module
422 receiving module
431 dividing of a frequency band
432 transmitting of first two reference signals
433 informing about availability of further or additional reference signals
434 transmitting of further or additional reference signals
435 determining of reference signals to be transmitted by a mobile node or user equipment to a base station or NodeB
436 transmitting of determined reference signals to the base station or NodeB
437 performing of channel estimation
D data
T₁ reference signal
T₂ reference signal
T₃ reference signal
T₄ reference signal

1. Method for channel estimation in a communications network, wherein said method comprises:
transmitting first two reference signals by a base station to a set of mobile nodes in said communications network, wherein said base station comprises first two antenna ports and wherein each of said first two reference signals refers to one antenna port of said first two antenna ports; and
transmitting at least one second reference signal by said base station to a cooperating mobile node, wherein:
said cooperating mobile node is comprised in said set of mobile nodes;
said cooperating mobile node is assigned to a cooperation area in said communications network, said cooperation area being defined by said base station; and
said at least one second reference signal refers to a corresponding further antenna port of further antenna ports comprised in said base station.

2. The method according to claim 1, wherein said method comprises transmitting of a control message by said base station to said cooperating mobile node, said control message indicating that said cooperating mobile node is assigned to said cooperation area, and wherein said at least one second reference signal is transmitted after said transmitting of said control message.

3. The method according to claim 1, wherein said at least one second two reference signal is transmitted in a message indicating availability of said further antenna ports.

4. The method according to claim 1, wherein said method comprises dividing of a frequency band of said base station into:
a first sub band configured for said transmitting of said first two reference signals; and
a second sub band configured for said transmitting of said at least one second reference signal.

5. The method according to claim 4, wherein said second sub band is configured for said transmitting of said first two reference signals.

6. The method according to claim 1, wherein said transmitting of said at least one second reference signal is performed by use of a whole frequency band.

7. The method according claim 1, wherein said method comprises transmitting of at least one dedicated reference signal by said base station to said cooperating mobile node after assigning of said cooperating mobile node said to cooperation area.

8. The method according to claim 7, wherein said at least one second reference signal is precoded before said transmitting of said at least one second reference signal.

9. The method according to claim 1, wherein said at least one second reference signal represents a resource block.

10. A computer program product comprising a code, the code being configured to implement a method according to claim 1.

11. A data carrier comprising a computer program product according to claim 10.

12. A base station, wherein said base station comprises a transmitting module, said transmitting module being configured for:
transmitting first two reference signals to a set of mobile nodes in said communications network, wherein said base station comprises first two antenna ports and wherein each of said first two reference signals refers to one antenna port of said first two antenna ports; and
transmitting at least one second reference signal to a cooperating mobile node, wherein:
said cooperating mobile node is comprised in said set of mobile nodes;
said cooperating mobile node is assigned to a cooperation area in said communications network, said cooperation area being defined by said base station; and
said at least one second reference signal refers to a corresponding further antenna port of further antenna ports comprised in said base station.

13. A mobile node, wherein said mobile node comprises a receiving module, said receiving module being configured for:
receiving of first two reference signals from a base station in a communications network, wherein said base station comprises first two antenna ports and wherein each of said first two reference signals refers to one antenna port of said first two antenna ports; and
receiving of at least one second reference signal from said base station, if said mobile node is assigned to a cooperation area in said communications network, said cooperation area being defined by said base station, wherein said at least one second reference signal refers to a corresponding further antenna port of further antenna ports comprised in said base station.
